(19) United States
(12) Patent Application Publication
(10) Pub. No.: US 2009/0254851 A1
(43) Pub. Date: Oct. 8, 2009

(54) METHOD AND SYSTEM FOR CONDUCTING A SURVEY BY USING A WIRELESS DEVICE

(75) Inventors: Brenton Porter Scott, North Vancouver (CA); Stefan Andrew Mohr, North Vancouver (CA); Aaron John Pazurik, Vancouver (CA); Mark Ryan Cameron, Gibsons (CA)

Correspondence Address: NEXUS LAW GROUP LLP, 1500 - 701 WEST GEORGIA STREET, VANCOUVER, BC, V7Y 1C6, CA

(73) Assignee: TECHNEOS SYSTEMS INC., Vancouver (CA)

(21) Appl. No.: 12/099,285

(22) Filed: Apr. 8, 2008

(51) Int. Cl. G06F 3/048; G06F 12/02; G06F 17/30; G06F 7/06

(52) U.S. Cl. 715/772; 707/205; 707/10; 707/5; 707/102; 707/E17.143

(57) ABSTRACT

A method of conducting a survey by a wireless device having a memory circuit and a display screen, the wireless device being capable of wireless communication with a server during a connection period, is provided. The method involves: downloading from the server during the connection period a metadata variable; displaying on the display screen of the wireless device presentation information associated with the metadata variable; receiving user input in response to the presentation information; after receiving the user input, allocating memory of the memory circuit for storing the user input in association with the metadata variable; and storing the user input in the memory in association with the metadata variable. A system for conducting a survey by a wireless device includes a server and a plurality of the wireless devices.

### BACKGROUND OF THE INVENTION

1. Field of Invention

This invention relates to conducting surveys, including opinion polls, questionnaires and the like, and, in particular, to conducting a survey by using a wireless device.

2. Description of Related Art

Computer program methods and systems have been developed to facilitate the collection and analysis of social science research data, and some such computer program methods and systems are commercially available. Such commercially available computer program methods and systems facilitate conducting surveys, including questionnaires, opinion polls and the like, but are not well suited for conducting such surveys by using a wireless device, including devices having a wireless Internet connection such as a wireless connected personal or laptop computer and including wireless mobile devices such as a personal digital assistant or cellular telephone.

Some conventional methods and systems for conducting surveys have been directed to conducting surveys involving Internet-connected devices such as personal computers. Such personal computers often have a wired connection to the Internet such that the personal computer is continuously connected to the Internet during participation of the Internet-based survey. Where an Internet connection is interrupted, the survey being conducted by such conventional Internet-based methods or systems is also interrupted, causing disruption to the user who may then lose interest and not subsequently complete the survey. However, many wireless devices are intermittently connected for communications, which may in some cases be intentional in order to reduce wireless connection costs or unintentional due to limitations in wireless connectivity near obstacles to radio frequency wave transmission. Furthermore, communications connections for wireless devices are frequently interrupted by low speed performance, including intermittently low speed performance and varying speed performance such as speed performance that varies by changing location. Thus, such conventional methods and systems are not suitable for conducting surveys using all wireless devices due to the possibility of an intermittent, non-continuous, intermittently low speed, and/or varying speed communications connection associated with one or more wireless devices or wireless device types.

Some conventional methods and systems for conducting surveys rely on the use of standard amounts of computer memory storage for storing survey data, including survey questions and survey response data. However, such conventional methods or systems are not suitable for use with all wireless devices due to limitations in available memory storage within one or more wireless device types, including one or more wireless mobile device types.

Some conventional methods and systems for conducting surveys have allowed users to build forms for displaying text and graphics associated with a survey, including forms that specify coordinates on a computer display for displaying text associated with a survey question, displaying text associated with possible answers of a multiple-choice type survey question, and/or displaying text entry areas for displaying text that is input by the user as a response to a survey question. However, forms created by using such conventional methods or systems are not suitable for use with all wireless device types due to incompatibility with the display methods of one or more mobile device types.

Some conventional methods and systems for conducting surveys have focused on facilitating surveys involving a few participants, or a few participants at a time. However, the ubiquitous nature of wireless communications networks have made it desirable to invite or recruit dozens, hundreds or thousands of potential participants and to conduct surveys involving dozens, hundreds or thousands of recruited participants. Such conventional methods and systems for conducting surveys lack desirable participant management features for inviting, recruiting or involving such large numbers of participants in surveys using wireless devices.

### SUMMARY

The above shortcomings may be addressed by providing, in accordance with a first aspect of the invention, a method of conducting a survey by a wireless device having a memory circuit and a display screen, the wireless device being capable of wireless communication with a server during a connection period. The method includes the steps of: (a) downloading from the server during the connection period a metadata variable; (b) displaying on the display screen of the wireless device presentation information associated with the metadata variable; (c) receiving user input in response to the presentation information; (d) after receiving the user input, allocating memory of the memory circuit for storing the user input in association with the metadata variable; and (e) storing the user input in the memory in association with the metadata variable.

Performing step (a) may involve downloading from the server a script command. The method may further involve executing the script command at an event time selected from the group consisting of: a first event time prior to generating the presentation information, and a second event time after receiving the user input. Performing step (a) may involve downloading a metadata record, the metadata record containing metadata, the metadata comprising the metadata variable, a user interface definition, and at least one of a metadata category and a metadata string, where the user interface definition may include the script command. Performing step (a) may involve downloading a response case record, where the response case record may include stored user input. Performing step (a) may involve downloading a response case record, where the response case record may include header data. Performing step (a) may involve downloading a data set from the group consisting of: metadata of a variable definition type, metadata of a category type, metadata of a string type, and metadata of a user interface type. The method may further involve: determining a version of the data set; downloading from the server a version identifier indicating a current version of the data set; and updating the data set if the version does not match the current version. Performing step (b) may involve executing a display command in accordance with a cross-platform software specification. Performing step (b) may involve generating the presentation information in accordance with the metadata. The method may further involve storing a display identification in the memory circuit in association with the presentation information. The method may further involve uploading to the server a location associated with the wireless device and downloading from the server a metadata record associated with the location, the metadata record comprising the metadata variable. Performing step (a) may involve downloading a response case record. The method may further involve generating status information in accordance with the response case record, and displaying the status information on the display screen. The method may further involve creating a response case record, associating the response case record with the metadata variable, generating status information in accordance with the response case record, and displaying the status information on the display screen.

In accordance with another aspect of the invention, there is provided a system for conducting a survey by a wireless device having a memory circuit and a display screen, the wireless device being capable of wireless communication with a server during a connection period. The system includes: the server; and a plurality of the wireless devices, each wireless device being operable to perform method steps of the invention. The server may be operable to create the metadata variable, a metadata record and a task data structure, to store the metadata variable within the metadata record, to store the metadata record within the task data structure, and may be operable to associate the task data structure with one or more of the wireless devices. The server may be operable to create a response case record and header data, and may be operable to store the header data within the response case record. The server may be operable to create a plurality of the task data structures, to receive from one or more of the wireless devices location information, and may be operable to associate one or more of the task data structures with one or more of the wireless devices in response to the location information.

In accordance with another aspect of the invention, there is provided a wireless device for conducting a survey, the wireless device having a memory circuit and a display screen, the wireless device being capable of wireless communication with a server during a connection period. The wireless device includes: downloading means for downloading from the server during the connection period a metadata variable; displaying means for displaying on the display screen of the wireless device presentation information associated with the metadata variable; receiving means for receiving user input in response to the presentation information; allocating means for, after receiving the user input, allocating memory of the memory circuit for storing the user input in association with the metadata variable; and storing means for storing the user input in the memory in association with the metadata variable.

The wireless device may further include generating means for generating the presentation information.

In accordance with another aspect of the invention, there is provided a computer program product comprising computer-executable instructions embodied in a computer-readable medium for performing method steps of the invention.

Other aspects and features of the present invention will become apparent to those of ordinary skill in the art upon review of the following description of embodiments of the invention in conjunction with the accompanying figures and claims.

### BRIEF DESCRIPTION OF THE DRAWINGS

In drawings which illustrate by way of example only embodiments of the invention:

FIG. 1 is a block diagram of a system for conducting a survey by using a wireless device in accordance with a first embodiment of the invention;

FIG. 2 is a flow diagram of a method of the system shown in FIG. 1, showing the step of allocating memory of a memory circuit of the wireless device for storing user input in association with a metadata variable;

FIG. 3 is a flow diagram of a method of the system shown in FIG. 1, the method implementing a first method step shown in FIG. 2 for downloading from the server a metadata variable;

FIG. 4A is a flow diagram of a first portion of a method of the system shown in FIG. 1, showing a method step of executing any on-enter script commands;

FIG. 4B is a flow diagram of a second portion of the method shown in FIG. 4A, showing method steps for executing any on-answer and any on-exit script commands;

FIG. 4C is a flow diagram of a third portion of the method shown in FIG. 4A, showing a method step of executing any on-save script commands;

FIG. 5 is a flow diagram of a method of the system shown in FIG. 1, showing a method step of displaying a list of tasks on a display of the wireless device, and subsequent steps;

FIG. 6 is a flow diagram of a method of the system shown in FIG. 1, showing a method step of receiving a user notification associated with the wireless device, and subsequent steps;

FIG. 7 is a flow diagram of a method of the system shown in FIG. 1, showing synchronization and updating method steps;

FIG. 8 is a flow diagram of a method of the system shown in FIG. 1, showing a method step of creating a task, and subsequent steps; and

FIG. 9 is a flow diagram of a method of the system shown in FIG. 1, showing a method step of selecting a task associated with a location in the vicinity of the wireless device.

### DETAILED DESCRIPTION

A wireless device for conducting a survey, having a memory circuit and a display screen, and being capable of wireless communication with a server during a connection period, includes: downloading means for downloading from the server during said connection period a metadata variable; displaying means for displaying on said display screen of the wireless device presentation information associated with said metadata variable; receiving means for receiving user input in response to said presentation information; allocating means for, after receiving said user input, allocating memory of said memory circuit for storing said user input in association with said metadata variable; and storing means for storing said user input in said memory in association with said metadata variable.

A system includes the wireless device and server means for making tasks available for downloading by the wireless device.

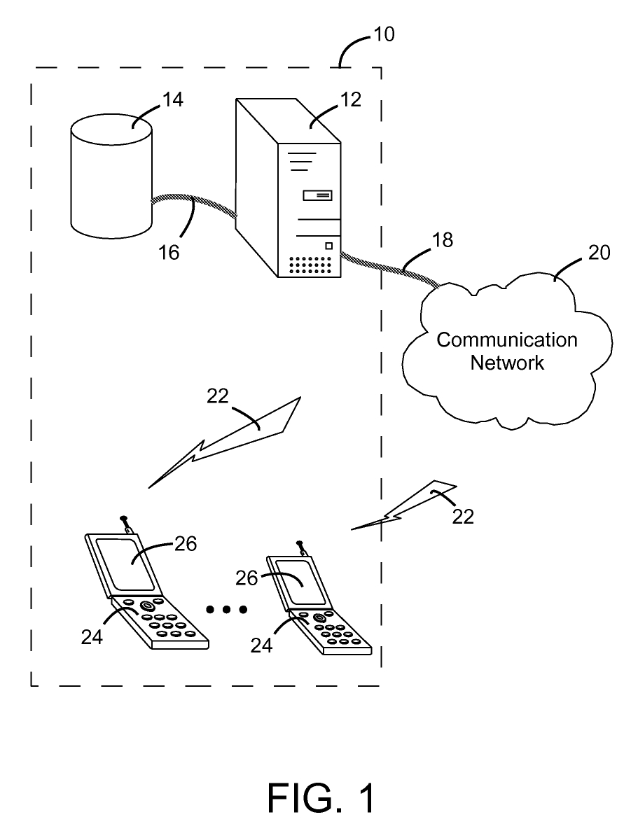

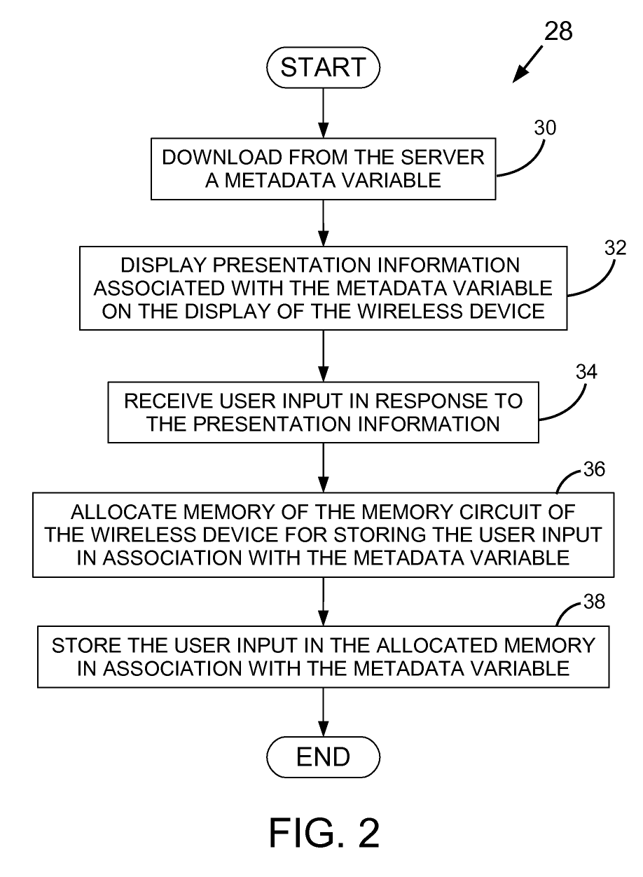

Referring to FIGS. 1 and 2, the system according to a first and preferred embodiment of the invention is shown generally at 10. The system 10 function to permit users to conduct surveys, including opinion polls, questionnaires, social research queries and the like, by using a wireless device. The system 10 includes a server 12, and a server database 14 shown in FIG. 1 connected to the server 12 by a database connection 16.

As shown in FIG. 1, the server 12 is connected by a communications connection 18 to a communication network 20, which in turn is connected by wireless connections 22 to any number of wireless devices 24. Each wireless device 24 has a display 26 for displaying text and/or graphics, including photographs and video, in a manner generally known in the art.

The server 12 may be any computing device such as a server computer, general purpose computer, microcomputer, minicomputer, mainframe computer, personal home computer, desktop computer, laptop computer, personal digital assistant, mobile telephone, distributed network for computing, functionally equivalent discrete hardware components, etc. and any combination thereof, for example. Typically, the server 12 is established at one location.

Each wireless device 24 may also be any computing device or other communications device, including a mobile communications device capable of wireless communications via the Internet. Examples of a wireless device 24 may include a cellular telephone, satellite telephone, smart phone, cordless phone, pager, personal digital assistant, personal navigation device, bluetooth headset, radio, including a two-way radio, handheld game console, portable media player, eBook reader, mobile personal computer, modem, ultra-mobile personal computer, notebook personal computer, wireless connected laptop computer, portable communications device, or any other handheld or portable device useable for wireless communications. The wireless device 24 may be intermittently, continuously or alternately intermittently and continously connected to the communication network 20, for example.

Each of the server 12 and wireless devices 24 include a processing circuit and a memory circuit encased therein in a manner known in the art. The processing circuit typically includes one or more circuit units, such as a central processing unit (CPU), digital signal processor (DSP), embedded processor, etc., and any combination thereof operating independently or in parallel, including possibly operating redundantly. The processing circuit may be implemented by one or more integrated circuits (IC), including being implemented by a monolithic integrated circuit (MIC), an Application Specific Integrated Circuit (ASIC), a Field Programmable Gate Array (FGA), etc. or any combination thereof. Additionally or alternatively, the processing circuit may be implemented as a programmable logic controller (PLC), for example. The processing circuit may include circuitry for storing memory, such as digital data, and may comprise the memory circuit or be in wired communication with the memory circuit, for example.

The database 14 and the memory circuits encased within the server 12 and the wireless devices 24 are typically each all or part of a digital electronic integrated circuit, or a combination of electrically connected digital electronic integrated circuits. The database 14 and the memory circuits encased within the server 12 and the wireless devices 24 may be implemented as volatile memory, non-volatile memory or both volatile and non-volatile memory, and may include Random Access Memory (RAM), Read-Only Memory (ROM), Programmable Read-Only Memory (PROM), Erasable Programmable Read-Only Memory (EPROM), Electrically Erasable Programmable Read-Only Memory (EEPROM), flash memory, one or more flash drives, universal serial bus (USB) connected memory units, magnetic storage, optical storage, magneto-optical storage, etc. or any combination thereof, for example.

The database 14 may be implemented as part of the processing circuit of the server 12, the memory circuit of the server 12, or may be implemented separately from the server 12 as shown in FIG. 1. The database 14 typically functions to store information, typically in the form of recordable and retrievable data for use within or by the system 10, including data records stored in association with other data records.

The system 10, including each of the server 12 and the wireless devices 24, is typically operable to run any one or more operating systems, including real-time operating systems such as WinCE, Symbian, OSE, Embedded LINUX, non-real time operating systems such as Windows, Unix, Linux, and any combination thereof. The system 10 may be operable to implement multi-tasking methods involving multiple threads of executable code, for example. Typically, an operating system of the server 12 is capable of running a Java EE (trademark) server platform or other suitable server platform.

The communications connection 18, communication network 20 and wireless connections 22 typically do not form part of the system 10, may separably or together include any suitable infrastructure elements for wired and/or wireless communications, and may include the Internet or portions thereof, cellular telephone links, satellite links, personal communications service (PCS) links, local area network (LAN) links, wide area network (WAN) links, wireless Internet links, line-of-sight free optical links, fiber-optic transmission links, cable links, including coaxial cable and twisted pair links, or any combination thereof for example. The wireless connections 22 each include at least one portion thereof that is wireless, and typically provide wireless connectivity at the wireless devices 24.

### Method of Operation

Referring to FIG. 2, the memory circuit of a given wireless device 24, in accordance with the first embodiment of the invention, contains blocks of code comprising computer executable instructions for directing the processing circuit of the given wireless device 24 to perform the steps of a method shown generally at 28. Additionally or alternatively, such blocks of code may form part of a computer program product comprising computer executable instructions embodied in a code bearing medium, which may be a recordable computer readable medium or a signal transmission type medium, for example.

When electrical power is being supplied to the processing circuit and the memory circuit of the given wireless device 24, its processing circuit is directed to begin executing the instructions of block 30. Reference herein to blocks of code associated with the methods of the present invention directing a wireless device 24 or directing the server 12 to perform some action is understood to refer to directing the processing circuit of that wireless device 24 in conjunction with its memory circuit and other related components thereof or directing the processing circuit of the server 12 in conjunction with its memory circuit and other related components thereof, respectively.

Block 30 directs the wireless device 24 to download from the server 12 a metadata variable. Downloading data from the server 12 to a given wireless device 24 involves receiving the data at the wireless device 24 after such data has been transmitted from the server 12 to the given wireless device 24 via a transmission pathway that, in the first embodiment and as shown in FIG. 1, includes the communications connection 18, the communication network 20 and the wireless connection 22. Other transmission pathways are possible, provided wireless connectivity is provided between the server 12 and the wireless devices 24. In the first embodiment, each wireless device 24 is operable to download the metadata variable in conjunction with downloading other metadata variables and other metadata described further herein below.

The system 10 is operable to effect downloading during any connection period of time that communications are established between the server 12 and the wireless device 24, including during intermittently available periods of time. The system 10 is operable to effect other system 10 functions not requiring or involving the transmission of data between the server 12 and the wireless device 24 even when such communications are not established, thereby advantageously permitting surveys to be conducted by using the wireless device 24 without requiring that the wireless device 24 have a continuous and/or constant communication connection with the server 1 2.

A metadata variable can be any variable capable of being electronically stored and/or transmitted in digital format. A variable may be or include any representation of a survey question, or portion thereof. The system 10 is preferably operable to generate a survey question in accordance with the metadata variable, including in conjunction with other metadata, and to display the survey question on the display 26 of the wireless device 24. In typical operation of the system 10, displaying a survey question on the display 26 poses that survey question to a user participating in the survey.

Block 32 then directs the wireless device 24 to display presentation information associated with the metadata variable on the display 26 of the wireless device 24.

Presentation information can be any information suitable for displaying on the display 26 of the wireless device 24. The system 10 is preferably operable to generate presentation information in accordance with the metadata variable (downloaded by executing block 32 for example), including in conjunction with other metadata. For example, the wireless device 24 may be directed to generate presentation information suitable for displaying by performing any suitable graphic conversion, display processing, or the like. Examples of presentation information include any digital representation of text and/or graphics, including photographs and video, to be displayed on the display 26, and any display instructions related thereto.

Block 34 then directs the wireless device 24 to receive user input in response to the presentation information being or having been displayed on the display 26.

The wireless device 24 is preferably operable to receive user input as any digital representation of user input entries, which may be entered into the wireless device 24 by the user using any suitable user input techniques, including one or more keyed entries, touchscreen input, touchpad input, tracking pad input, voice input, including voice input with voice recognition, menu selection or any other mode of user input or combination thereof for example. User input can include any digital representation of the user's answer in response to a particular question of a survey being conducted, for example.

Block 36 directs the wireless device 24 to allocate memory of the memory circuit of the wireless device 24 for the purpose of storing the user input (received by executing block 34 for example) in association with the metadata variable (downloaded by executing block 30 for example).

Block 38 directs the wireless device 24 to store the user input (received by executing block 34 for example) in the memory allocated by executing block 36 in association with the metadata variable (downloaded by executing block 30 for example).

In general and in embodiments of the invention, block 36 can be executed at any time after executing block 30 and before executing block 38, such that memory of the memory circuit of the wireless device 24 is allocated after downloading the metadata variable and before storing the user input in the allocated memory in association with the downloaded metadata variable. In the first embodiment, the system 10 advantageously permits user input to be stored for later retrieval without requiring the wireless device 24 to be in communication with the server 12 at the time such user input is stored. In circumstances where the wireless device 24 is in communication with the server 12 at the time such user input is being stored, the system 10 is operable to store the user input within the memory circuit of the wireless device 24, within the memory circuit of the server 12, or both within the memory circuit of the wireless device 24 and the memory circuit of the server 12.

Preferably, the wireless device 24 is operable to allocate memory for storing user input in association with the metadata variable after the user input is received. In some embodiments, the wireless device 24 is operable to store user input on a temporary basis, such as in RAM or other volatile memory. Additionally or alternatively, the wireless device 24 is preferably operable to allocate memory in the memory circuit for storing the user input in association with the metadata variable on an indefinite basis. By way of examples of storing user input on an indefinite basis, the user input stored in the allocated memory of the wireless device 24 may be retrievable after any process, operation or method of the system 10 is terminated; after the wireless device 24 has been turned off while retaining power to the allocated memory, such by maintaining battery or charging power to the wireless device 24 for example; after the wireless device 24 has been turned off and all power sources to the wireless devices 24 have been removed; or any combination thereof. The allocated memory may be volatile memory (such as memory maintained by battery or charging power even when the wireless device 24 is turned off) or non-volatile memory, for example. Storing the user input in the allocated memory on an indefinite basis advantageously permits a user to resume participating in a survey, after the wireless device 24 has been turned off and subsequently turned on for example, without any loss of previously entered user input.

In embodiments of the invention, the system 10 is operable to store the user input within a data structure, for example. Such data structure may be a hierarchical or relational database, for example. The amount of memory that is allocated may vary with the type of user input that is received, with the particular user input that is received, or may depend simply on whether or not user input is received, for example.

Allocating memory for storing the user input in association with the metadata variable after receiving the user input advantageously reduces the use of memory within the wireless device 24 by limiting such use to an as-needed only basis. The allocation of memory for all possible user input that might be received during the course of conducting a survey is thereby avoided, and the size of the data structure required to store the metadata variable and its associated response is expanded only as required to store the user input that is received.

After block 38 has been executed, the wireless device 24 is then directed to end the method 28.

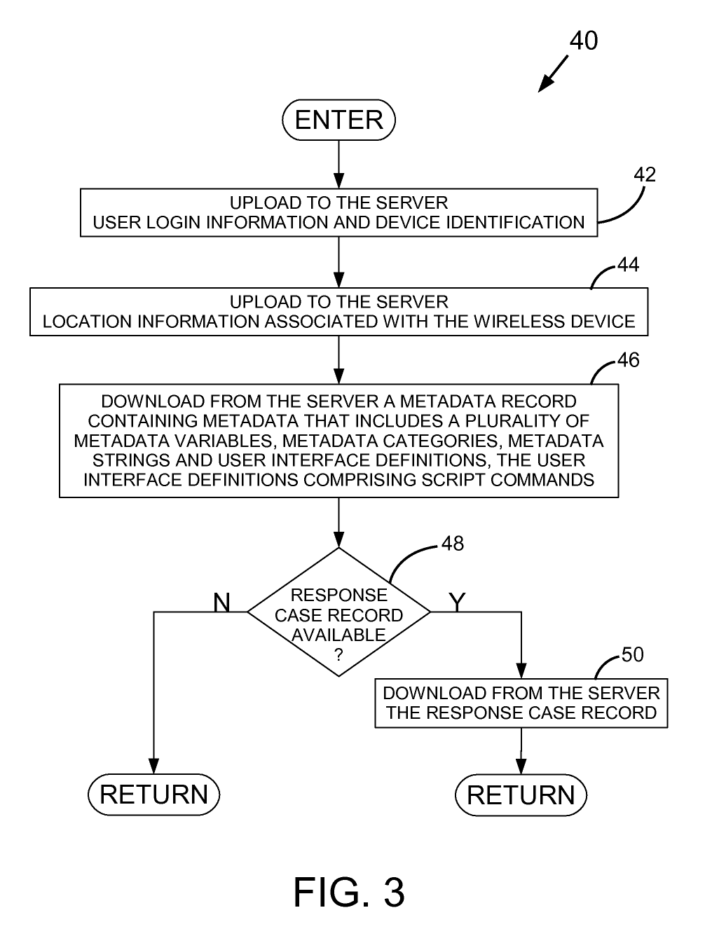

Referring to FIG. 3, an exemplary method that includes an implementation of block 30 (FIG. 2) is shown generally at 40.

Method 40 of FIG. 3 begins by executing block 42, which directs the wireless device 24 to upload to the server user login information and device identification. Generally, the system 10 is operable to permit and to require each user to log into the system 10 before using the wireless device 24 to communicate with the server 12 for the purposes of conducting a survey. The system 10 is also operable to permit a user or potential user to access the system 10 without logging into the system 10, such as during initial set up or in initially responding to a solicitation to participate in a survey for example. The feature of uploading user login information is not implemented in some embodiments of the invention.

The system 10 feature of uploading device identification to the server 12 advantageously permits the system 10 to associate a given wireless device 24 with a given user, and advantageously facilitates verification of such association and user authentication.

Block 44 directs the given wireless device 24 to upload to the server location information associated with that wireless device 24. In some embodiments, the system 10 is operable to permit or require a given user to conduct a survey that includes one or more location-related questions, and to provide such location-specific survey to users located in specified locations. In such embodiments, the wireless device 24 is advantageously operable to upload to the server information indicating its location. Such location information may include digital representations of geographical coordinates obtained from any of radio positioning systems, wireless Internet positioning systems, satellite positioning systems, or any combination thereof for example. Block 44 is not executed in some embodiments of the invention.

Block 46 directs the wireless device 24 to download from the server a metadata record containing metadata. In the first embodiment, the system 10 is operable to make use of any of four types of metadata: a variable definition type, a category type, a string type and a user interface type. In the first embodiment, metadata of the user interface type includes display properties for determining and managing the manner in which presentation information associated with metadata of the variable definition type, the category type and the string type is displayed on the display 26 of the wireless device 24. The separation between storage and management of metadata related to manners of displaying and metadata related to what is being displayed advantageously permits the system 10 to use metadata related to what is being displayed with different types of wireless devices 24. Additionally or alternatively, such separation advantageously facilitates the iterative display of the same information multiple times in different manners on the same or different wireless devices 24.

The metadata that is downloaded includes the metadata variable illustrated in and described herein above with reference to FIG. 2. In the first embodiment and as shown in FIG. 3, block 46 directs the wireless device 24 to download from the server 12 metadata which includes a plurality of metadata variables. The plurality of metadata variables are each of the variable definition type, and are typically stored together in a data structure that is downloaded from the server. The data structure may inherently, implicitly or explicitly provide an order to the metadata variables such that by default presentation information associated with a first metadata variable is displayed on the display 26 before presentation information associated with a second metadata variable is displayed, and so on. Preferably, the system 10 is operable to override such default ordering of metadata variables and display presentation information in accordance with an ordering other than the default ordering of metadata variables.

In general, each metadata variable is typically defined by any one or more of a variable identification number; a variable alias, which may be any mnemonic for the variable identification number; a variable definition type, which indicates the type of the metadata variable; and a variable definition category, which is an indication of a metadata category (described further herein below) to which the metadata variable references. Examples of variable definition types include open-ended text, open-ended numeric, date, time, single categorical, multiple categorical, ranking, etc.

Block 46 also directs the wireless device 24 to download from the server 12 metadata which includes a plurality of metadata categories. Each metadata category is of the category type of metadata. A metadata category is typically implemented as a list of potential responses from among which a user can select, thereby providing an answer to a survey question. For example, presentation information associated with a metadata variable may be displayed on the display 26 as “Which of the following is your favourite colour?”, and presentation information associated with a corresponding metadata category may be displayed on the display 26 as “Blue; Green; Yellow; None of the Above”. Each metadata category is generally defined by any one or more of a category identification number; a category alias, which may be any mnemonic for the category identification number; and a category item list, each listed item of which is defined by a category string, a category value and a category order. Preferably, each category string of a given listed item defines the text for the given listed item (e.g. “Blue”, “Green”, “Yellow”, etc.). The category value is a numerical representation of the category string. The category orders associated with the given listed items define a default order in which the category strings are displayed. The category order associated with a category string may be, but need not be, the same as the category value associated with that category string. If the category string “Green” is associated with the category order 2, the category string “Blue” is associated with the category order 1 and the category string “Yellow” is associated with the category order 3, then such category strings would be displayed in the order of “Blue”, then “Green”, and then “Yellow”, for example. The order in which the category strings are displayed need not be the default order, but for example may be determined in accordance with one or more display properties of the metadata, in accordance with one or more script commands, or in accordance with both one or more display properties of the metadata and one or more script commands, and may be determined during execution of a process, operation or method of the system 10.

Block 46 also directs the wireless device 24 to download from the server 12 metadata which includes a plurality of metadata strings. Each metadata string is of the string type of metadata. A metadata string is typically a text string available for displaying on the display 26 of the wireless device 24. Each metadata string is generally defined by any one or more of a string identification number; a string alias, which may be any mnemonic for the string identification number; and one or more instances of text in a specified language. Preferably, each instance is associated with a distinct language, and a default language, such as English, may be set as a system 10 parameter. The system 10 is preferably operable to permit a user of the wireless device 24 to select and change the language and set the default language for the system 10 operation.

Still referring to block 46 shown in FIG. 3, the metadata can also include a plurality of user interface definitions, with each user interface definition being of the user definition type of metadata. In the first embodiment, the system 10 is operable to determine from a user interface definition the manner in which associated metadata variables and metadata strings are displayed, and associated display properties. Each user interface definition is generally comprised of one or more user interface groups, where each user interface group is defined by a user interface group identification number; and a user interface group alias, which may be any mnemonic for the user interface group identification number. In the first embodiment, each user interface group includes one or more user interfaces. Each user interface is generally comprised of any one or more of a user interface identification number; a user interface alias, which may be any mnemonic for the user interface identification number; one or more variable groups; one or more labels; and one or more script commands.

A variable group includes one or more indexed variable references. Each variable reference is generally comprised of any one or more of a variable identification; a category definition; a string identification; and one or more associated display properties. The system 10 is operable to use the variable identification, category identification and string identification to advantageously associate a given variable reference with a given metadata variable, metadata category and metadata string, respectively.

The display properties determine the manner in which the associated metadata variables, metadata categories and metadata strings are displayed on the display 26 without specifying display 26 screen locations, thereby advantageously permitting variable references to be displayed on a variety of wireless devices 24 having different screen sizes and shapes without needing to specify where on the display 26 screen particular screen items are to be displayed. One example of a display property is an indication as to whether user input associated with the metadata variable (identified by the variable identification) must be received before the system 10 will generate and display presentation information associated with another variable reference or variable group. Another example of a display property is an indication of a display order for determining the order in which multiple variable references should be displayed on the display 26 of the wireless device 24. Examples of display orders that can be implemented by the system 10 include normal (e.g. displaying in the order in which the variable references are stored in the data structure); random (e.g. displaying in an order determined in accordance with a pseudo-random sequence); and rotated (e.g. with each new iteration of displaying a group of variable references, making a previously first displayed variable reference the second displayed variable reference, making the previously second displayed variable reference the third displayed variable reference, and so on, and making the previously final displayed variable reference the first displayed variable reference). Another example of a display property is the format for displaying the time and/or date (e.g. 01/01/1900, 1 Jan. 1900, etc.). Another example of a display property is the number of columns to use in displaying presentation information, which number may be from one to any specified maximum number of columns. Another example of a display property is specifications for determining the appearance of buttons, icons and other graphical user interface (GUI) items.

A label is typically comprised of a string identification for identifying a string containing the text of a survey question to be displayed on the display 26.

Script commands are used by the system 10 to affect the logical flow of its methods, including affecting the logical flow for displaying presentation information. As may be appreciated by a person of ordinary skill in the art, numerous effects within the capabilities of scripting in general can be produced by executing a script command. For example, the system 10 is operable to execute a script command to determine which survey question to subsequently display on the basis of previously received user input, operable to skip displaying presentation information that otherwise would be displayed by default ordering, iteratively display presentation information multiple times, and perform other scripted operations or any combination thereof.

Still referring to FIG. 3 and in some embodiments, block 48 directs the wireless device 24 to determine whether a response case record is available for downloading. A response case record is in general defined as a data structure for containing user input associated with given metadata. The system 10 is preferably operable to store such user input in an associated response case record. Each response case record is generally comprised of any one or more of a response case record identification number; a response case record alias, which may be any mnemonic for the response case record identification number; a time stamp for storing event times related to the response case record; a location stamp for storing locations, including desired locations for conducting a survey; contact information for a user with which the response case record is associated; response data, including data values, for storing user input provided by the user in response to presentation information; response index for indexing multiple instances of response data within the response case record; display identification for identifying previously displayed presentation information; and other related data about user responses to survey questions.

A response case record available for downloading may be empty of contents. Additionally or alternatively, a response case record available for downloading may contain some content data such as user input, pre-populated header data, or any combination thereof for example. By way of example, a user may be participating by completing a survey started at an earlier time, such as by that or another user, but not completed, in which case the response case record containing previously received and stored user input may be available for downloading to that user's wireless device 24. As a further example, a user may have been previously selected for participating in a new survey, in which case identification information (e.g. name, address) of the user, location information for the new survey, or any combination thereof, may already be stored in the response case record as pre-populated header data for the convenience of the user and such response case record having pre-populated header data may be available for downloading to that user's wireless device 24.

If a response case record is available for downloading, then block 50 directs the wireless device 24 to download the response case record, and the wireless device 24 is directed to return to block 32 of FIG. 2. If no response case record is available for downloading, then no response case record is downloaded and the wireless device 24 is directed to return to block 32 of FIG. 2.

While FIG. 3 shows one exemplary method 40 that includes directing the wireless device 24 to implement the instructions of block 30 (FIG. 2), other methods are possible. For example, in some embodiments the wireless device 24 is directed to request in a single communication to the server 12 all metadata and any associated response case records, such that the metadata record and the response case record are downloaded by executing the same block of code. In some embodiments, one or more metadata records and one or more response case records may be stored within a single data structure such that downloading the single data structure results in the one or more metadata records and the one or more response case records being simultaneously downloaded. In some embodiments, the metadata of a given metadata record and the contents of a given response data record form a single merged data structure comprising metadata and associated response case record contents, in which such associations may be implemented by indexing for example, such that downloading the single merged data structure results in the given metadata record and the contents of the given response case record being simultaneously downloaded. Other methods, including variations of the method 40, which effect the results of executing block 30 (FIG. 2) are also within the scope of contemplation for the present invention.

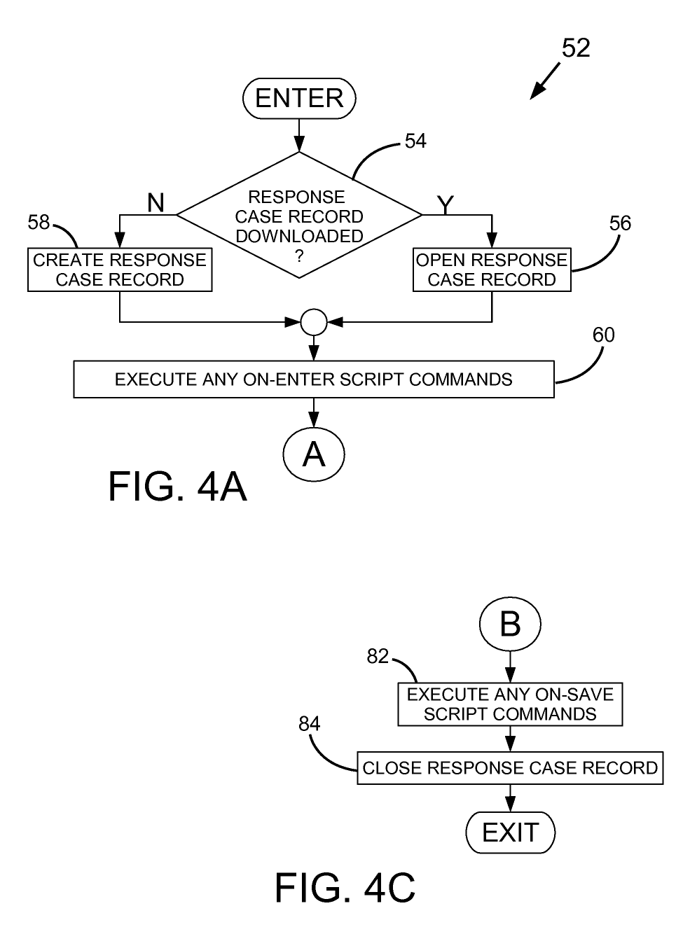

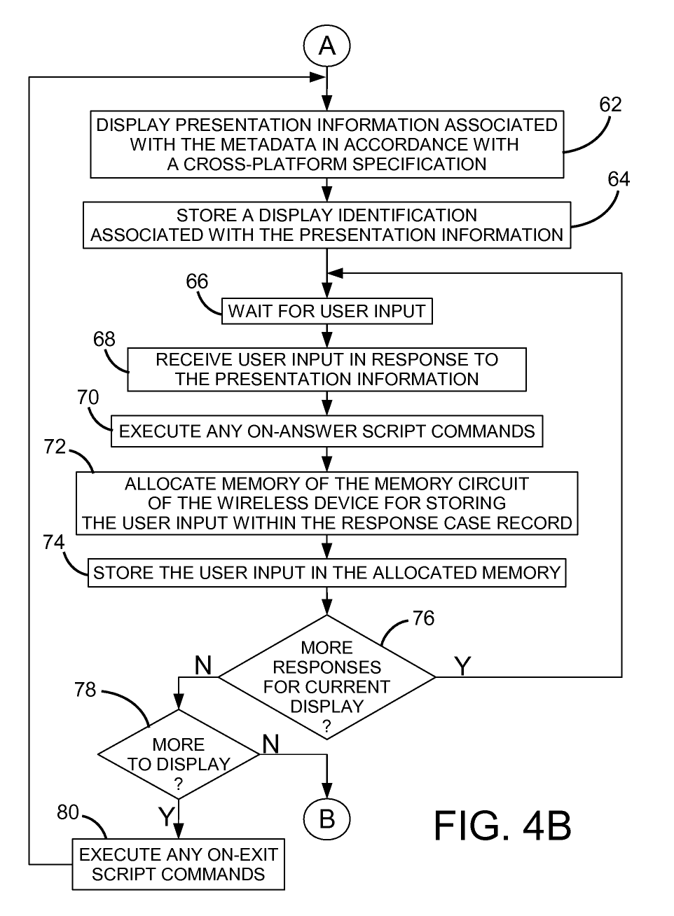

Referring to FIGS. 4A, 4B and 4C, an exemplary method that includes an implementation of blocks 32 to 38 (FIG. 2) is referenced generally in FIG. 4A at 52.

Method 52 begins by executing block 54, which directs the wireless device 24 to determine whether a response case record has been downloaded, such as being downloaded generally when downloading metadata for example. If a response case record has been downloaded, then block 56 directs the wireless device 24 to open (e.g. retrieve into volatile memory such as RAM) the response case record.

If no response case record has been downloaded, then block 58 directs the wireless device 24 to create a response case record, which typically includes opening the response case record that is created. Typically, a response case record that is newly created by the wireless device 24 does not contain any user input. A previously created response case record may or may not contain stored user input. The system 10 is preferably operable to permit a response case record to be closed before completion of a survey and after some user input has been stored in the response case record such that the response case record can be opened at a later time to resume the survey. In the first embodiment, a response case record for a given survey need not be closed in order to permit a user to resume participating in the given survey after power to the wireless device 24 has been removed and restored. In some embodiments, the system 10 is operable to require the completion of a survey, with or without interruption, before its corresponding response case record is closed, and may make such requirement in accordance with one or more script commands associated with that survey.

After block 56 or 58 is executed, block 60 then directs the wireless device 24 to execute any on-enter script commands. By way of example, a script command may be executed such that a user is prompted to enter the number of participants for a given group of participants, which may subsequently affect during the course of conducting the survey the number of times the same presentation information will be iteratively displayed. Other on-enter script commands and effects thereof are possible and are within the scope contemplated by the present invention. As shown in FIGS. 4A, 4B and 4C, block 60 is being executed prior to generating presentation information.

After block 60 of FIG. 4A is executed, the wireless device 24 is directed to execute block 62 shown in FIG. 4B.

Referring to FIG. 4B, block 62 directs the wireless device 24 to display, in accordance with a cross-platform specification, presentation information associated with metadata. Examples of a cross-platform specification include Java ME (Micro Edition), Java SE (Standard Edition) and Java EE (Enterprise Edition) platforms. Java is a trademark of Sun Microsystems, Inc. Any specification and its associated platform and programming environment components that permits the display of presentation information on a variety of wireless devices 24 may be suitably used. In the first embodiment, displaying presentation information in accordance with a cross-platform specification involves executing a display command in accordance with such cross-platform specification, where such display command may be defined by such cross-platform specification for example. In some embodiments, the system 10 is operable to display presentation information in accordance with a platform-specific specification, and a platform identification may be stored and managed as a system 10 parameter.

In the first embodiment, executing block 62 causes presentation information associated with downloaded metadata, such as the metadata downloaded by implementing method 40 (FIG. 3), to be displayed. Such downloaded metadata includes the metadata variable downloaded by executing block 30 (FIG. 2). In the first embodiment, displaying presentation information associated with downloaded metadata involves generating the presentation information in accordance with the user interface type of metadata and with reference to any or all of the variable definition type, the category type and the string type. Generating the presentation information in accordance with the user interface type preferably includes generating the presentation information in accordance with display properties defined by the user interface type of metadata (downloaded by executing the method 40, for example). In general, block 62 may be implemented in any manner identical, similar or analogous to that of block 32 (FIG. 2), for example.

Block 64 directs the wireless device 24 to store a display identification associated with the presentation information. In the first embodiment, executing block 64 is an optional feature of the system 10 that facilitates displaying previously displayed presentation information, thereby permitting a user to “back up” during the course of conducting a survey and have such previously displayed presentation information displayed again. Storing a display identification advantageously permits the system 10 to regenerate previously displayed presentation information without having to store large amounts of data representing the presentation information itself. In general, block 64 may be executed at any time before, during or after the presentation information is generated for displaying on the display 26, typically provided the presentation identification is stored after prior presentation information was previously generated and before new presentation information is subsequently generated. Preferably, the presentation identification for given presentation information is stored within the response case record associated with the metadata from which the given presentation information was generated.

Block 66 directs the wireless device 24 to wait for user input, which user input is typically provided by the user in response to the presentation information being displayed. The system 10 is in some embodiments operable to perform other operations while executing block 66.

Block 68 then directs the wireless device 24 to receive user input in response to the presentation information having been or being displayed on the display 26. Block 68 may be implemented in any manner identical, similar or analogous to that of block 34 (FIG. 2), for example.

Block 70 then directs the wireless device 24 to execute any on-answer script commands. For example, the system 10 is operable to verify the suitability or fitness for any purpose of user input received by executing block 68, and cause a responsive action to the results of such verification. In some embodiments, executing an on-answer script command may verify whether free text user input exceeds a specified length, is blank, or contain grammatical or orthographic errors, etc, and request re-entry of the user input, for example. The system 10 is operable to execute on-answer script commands such that logical flow may be advantageously affected for each iteration of blocks 66 to 74 that may occur, as shown in FIG. 4B.

Block 72 then directs the wireless device 24 to allocate memory of the memory circuit of the wireless device 24 for storing the user input (received by executing block 68 for example) in association with the metadata, which metadata can be downloaded by implementing the method 40 (FIG. 3). Such downloaded metadata includes the metadata variable downloaded by executing block 30 (FIG. 2). Preferably, the user input is stored within the response case record created or opened in accordance with blocks 54 to 58 shown in FIG. 4A. Preferably, the metadata is associated with the user input by associating the metadata with the response case record containing the user input. In the first embodiment, associating metadata with a case response record is implemented by storing within the response case record a variable reference identification. However, any suitable technique for associating metadata with user input may be implemented and is within the scope contemplated by the present invention. Allocating memory typically involves expanding the size of the response case record sufficiently to accommodate the user input (received by executing block 68). Typically, the response case record need not be expanded in size any more than is required to accommodate the user input, thereby advantageously minimizing memory storage use of the wireless device 24. Block 72 may be implemented in any manner identical, similar or analogous to that of block 36 (FIG. 2), for example.

Block 74 then directs the wireless device 24 to store the user input (received by executing block 68 for example) in the allocated memory (allocated by executing block 72 for example) in association with the metadata, which may suitably have been downloaded by implementing the method 40 (FIG. 3). Such downloaded metadata includes the metadata variable downloaded by executing block 30 (FIG. 2). Preferably, the user input is stored on an indefinite basis. Block 74 may be implemented in any manner identical, similar or analogous to that of block 38 (FIG. 2), for example.

Block 76 then directs the wireless device 24 to determine whether any more responses can be received for the current display of presentation information on the display 26 of the wireless device 24. In the first embodiment, the system 10 is operable to simultaneously display presentation information comprising of a multiple number of survey questions, and iteratively receive and store user input for each displayed question. In some embodiments, the system 10 is operable to generate and display new presentation information only after responses for each displayed question has been received as user input. In other embodiments, the system 10 is operable to permit a user to skip one or more questions, such as in response to receiving user input indicating the user's wish to skip such questions. Such user input may be received as a menu selection or null input, for example.

If there are more responses for the current display, the wireless device 24 is directed to execute blocks 66 to 74 again. If there are no more responses for the current display, including skipping over one or more otherwise possible responses, the wireless device 24 is directed to execute block 78.

Block 78 directs the wireless device 24 to determine whether there is more to display, such as whether there is more presentation information that can be generated in accordance with the metadata and can be displayed. Typically, presentation information is iteratively generated and displayed until presentation information in association with all of the metadata downloaded by method 40 (FIG. 3) has been displayed. If there is more to display, the wireless device 24 is directed to execute block 80.

Block 80 directs the wireless device 24 to execute any on-exit script commands. By way of example, the system 10 is operable to alter the flow of displaying presentation information in response to user input (such as that received by executing block 68). Executing an on-exit script may cause one or more survey questions to be skipped or repeated, for example. The system 10 is operable to execute on-exit script commands such that logical flow may be advantageously affected for each iteration of blocks 62 to 74 that may occur, as shown in FIG. 4B.

After block 80 is executed, the wireless device 24 is directed to iteratively execute blocks 62 to 78 until execution of block 78 results in the determination that there is no more to display.

If by executing block 78, the wireless device 24 determines that there is no more to display, then the wireless device 24 is directed to execute block 82 shown in FIG. 4C.

Referring to FIG. 4C, block 82 directs the wireless device 24 to execute any on-save script commands. For example, the system 10 is operable to display a closing message on the display 26; establish, re-establish or confirm the status of communication between the server 12 and the wireless device 24; synchronize a response case record between the wireless device 24 and the server 12, etc. The system 10 is operable to execute on-save script commands such that logical flow may be advantageously affected after all presentation information for a given survey has been displayed and prior to closing such survey's associated response case record, as shown in FIGS. 4A, 4B and 4C. After block 82 is executed, the method 52 proceeds to block 84.

As may be appreciated by a person of ordinary skill in the art, other effects than those provided herein above as examples can be created by executing an on-answer, on-exit and/or an on-save script command and are within the scope of contemplation of the present invention. In the first embodiment, blocks 70, 80 and 82 are each executed after receiving user input (received by executing block 68, for example), as shown in FIGS. 4A, 4B and 4C.

Block 84 directs the wireless device 24 to close the response case record that had been opened or created as shown in FIG. 4A. Closing the response case record may involve releasing volatile memory that had been used in processing the response case record, such as after saving the response case record on an indefinite basis, for example. In the first embodiment, the system 10 is operable to save the response case record in the memory circuit of the wireless device 24 before closing the response case record, for example, including having saved the response case record with each change thereto that may have occurred.

After block 84 has been executed, the wireless device 24 is directed to exit from the method 52.

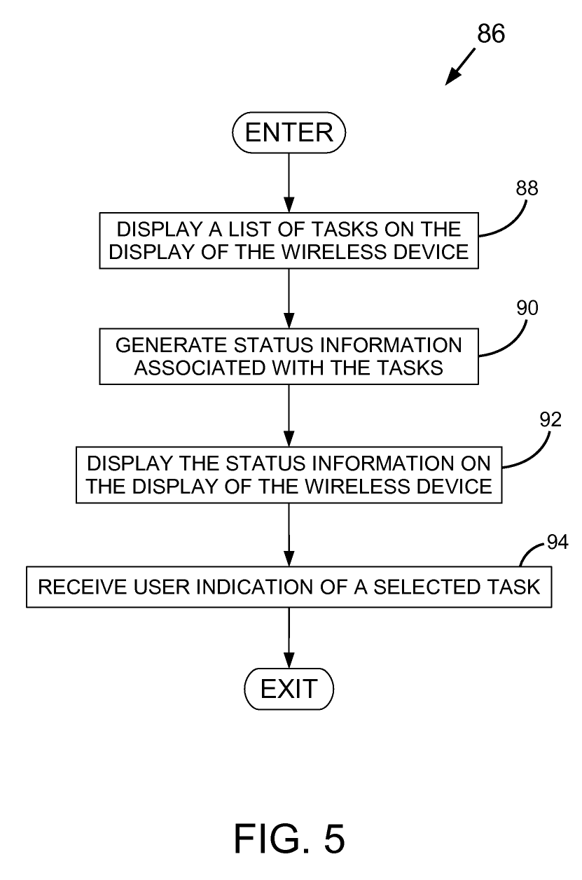

Referring to FIG. 5, the system 10 is preferably operable to provide a user of a wireless device 24 with a selection of one or more tasks from which the user may choose to conduct or complete. An exemplary method for providing the user with such selection is shown in FIG. 5 generally at 86.

Method 86 begins by executing block 88, which directs the wireless device 24 to display a list of tasks on the display 26 of the wireless device 24. Exemplary tasks include completing a questionnaire, conducting a single-person survey, conducting a household survey, performing social research services at a specified location, for example. In the first embodiment, a task is typically stored in memory as a task data structure which includes a user identification to associate the task with a given user and one or more task properties for specifying what action should be requested of the associated user. Generally, each task is preferably associated with or includes metadata for one social research project and any case response record that has been created in association with that metadata.

The wireless device 24 is preferably operable to display the list of downloaded tasks in a manner identical, similar or analogous to executing block 62 (FIG. 4B) and/or block 32 (FIG. 2).

Block 90 directs the wireless device 24 to generate status information associated with the listed tasks. The system 10 is preferably operable to implement block 90 as an optional feature. In the first embodiment, the wireless device 24 is operable to generate status information for each of one or more of the listed tasks. Such status information may include an indication as to whether a given task has been completely or partially performed, the number of times that a given task has been completely or partially performed, when a given task has been completely or partially performed, where a given task has been completely or partially performed, the total number of tasks a given user has completely or partially performed, the total number of tasks that have been completely or partially performed for a given third party customer, the number of disqualified tasks (e.g. tasks containing or otherwise associated with a disqualifying response from a user), whether a target number of completed tasks has been reached, the number of tasks completely or partially performed by a user having a specified gender (e.g. male, female, transgendered, etc.) or that is associated with another identifiable category (e.g. ethnic group, age group, purchasing history category, leisure time activity history category, asset ownership category, income category, medical history category, etc.), calculated statistics (e.g. average time to complete, ratio of disqualified tasks to qualifying completed tasks, ratio of tasks completed by males to females, etc.), or any combination thereof for example. In some embodiments, generating status information includes downloading server-generated status information from the server 12.

In the first embodiment, the system 10 is operable to store status information, including temporarily storing such status information, in memory using status information data structures, and each status information data structure typically includes a status information identification number; a status information alias, which may be any mnemonic for the status information identification number; and a test expression. The test expression is typically a conditional boolean expression for providing a boolean result with respect to a given response case record associated with a given listed task. In the first embodiment, generating status information for a given task involves performing the test expression with respect to the given response case record and storing the result in an associated status information data structure. In general, the status information of such status information data structure may be stored separately from or form part of any of the metadata record, response case record, task data structure, or any combination thereof for example.

In some embodiments, the wireless device 24 does not execute block 90. Alternatively or additionally, the wireless device 24 is in some embodiments operable to download status information, such as by downloading one or more status information data structures, from the server 12.

Block 92 directs the wireless device 24 to display the status information that was generated by executing block 88 on the display 26 of the wireless device 24 or downloaded from the server 12. Displaying such status information on the display 26 preferably involves executing one or more display commands in accordance with a cross-platform specification. In some embodiments, however, platform-specific display commands may be invoked. Block 92 may be implemented in a manner identical, similar or analogous to block 88, for example.

The order in which blocks 88 to 92 are executed may vary, and the execution of any of blocks 88 to 92 may be repeated. By way of example, status information may generated or otherwise obtained prior to displaying the list of tasks and the status information on the display 26. By way of further example, status information may be generated and then displayed before subsequently generating further status information.

Block 94 directs the wireless device 24 to receive a user indication of a selected task. The wireless device 24 is preferably operable to receive the user indication as any digital representation of user input entries entered by any suitable user input techniques, including exemplary user input techniques described herein above. The user indication can include a digital representation of the user's selection of a task displayed on the display by executing block 88, for example.

After block 94 has been executed, the wireless device 24 is directed to exit from the method 86. In the first embodiment, the wireless device 24 is typically directed to enter the method 52 (FIGS. 4A, 4B and 4C) described herein above after having exited the method 86 and having downloaded the task selected by executing block 94. In some embodiments, executing block 88 displays tasks which have been downloaded such that upon exiting the method 86 the wireless device 24 can be directed to enter the method 52 (FIGS. 4A, 4B and 4C). Additionally or alternatively, one or more of the displayed tasks may not have been downloaded or not fully downloaded such that further downloading of the selected task is necessary before the wireless device 24 enters the method 52 (FIGS. 4A, 4B and 4C).

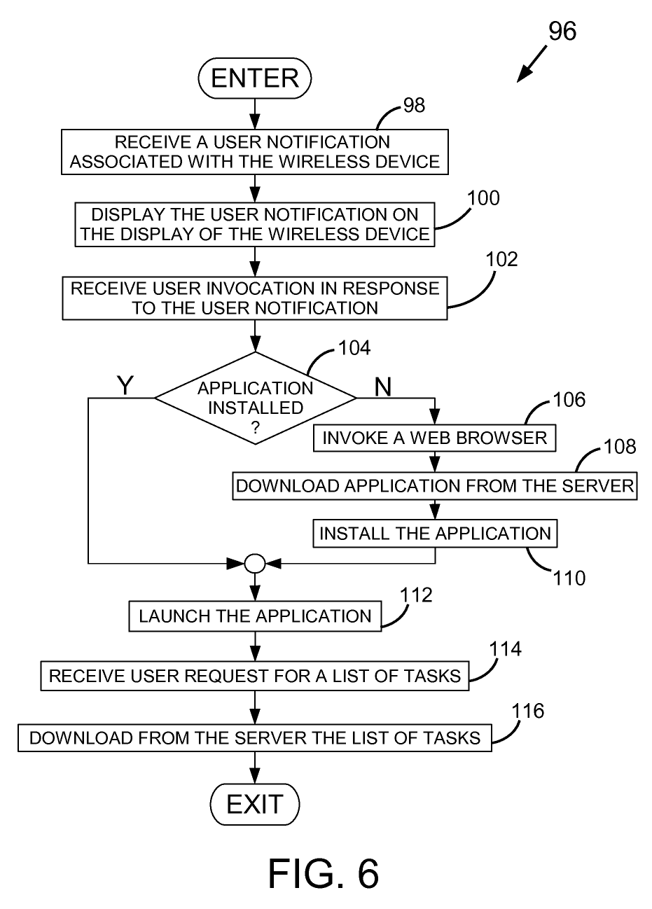

Referring to FIG. 6, the system 10 is operable to provide a user, including possibly a new user, with the opportunity to participate in one or more surveys. An exemplary method for providing the user with such opportunity is shown in FIG. 6 generally at 96.

Method 96 begins by executing block 98, which directs the wireless device 24 to receive a user notification associated with the wireless device. Receiving a user notification may involve receiving a Short Messaging Service (SMS) communication, Enhanced Messaging Service (EMS) communication, Multimedia Messaging Service (MMS) communication, Short Message Peer-to-Peer (SMPP) communication or other messaging type communication, an e-mail, a voice communication, or any similar or analogous notification or combination thereof, for example. In the first embodiment, the user notification is of a type that can be readily displayed on the display 26, such as in the form of text and/or graphics. In some embodiments, however, the user notification is of a different type, such as an aural voice communication, for example. In the first embodiment, after block 98 has been executed, the wireless device 24 is directed to execute block 100.

Block 100 directs the wireless device 24 to display the user notification on the display 26 of the wireless device 24. In the first embodiment, the wireless device 24 is operable to display the user notification by executing one or more display commands in accordance with a cross-platform specification. In some embodiments, however, platform-specific display commands may be invoked.

Block 102 directs the wireless device 24 to receive a user invocation in response to the user notification. The wireless device 24 is preferably operable to receive the user invocation as any digital representation of user input entries entered by any suitable user input techniques, including exemplary user input techniques described herein above. The user invocation can include a digital representation of the user's willingness to participate in a given survey, for example. Although not shown in FIG. 6, it will be appreciated that a user may simply ignore or cancel the user notification without providing such user invocation, in which case the method 96 terminates. After execution of block 102 and in the case where the user provides the user invocation, the wireless device 24 is directed to execute block 104.

Block 104 directs the wireless device 24 to determine whether the system 10 application has been installed in that wireless device 24. If the system 10 application has not been installed in the wireless device 24, then the method proceeds to execute blocks 106 to 110.

Blocks 106 to 110 direct the wireless device 24 to invoke a web browser or other HTTP user agent; use the web browser or other HTTP user agent to download the system 10 application from the server 12; and to install the system 10 application in the wireless device 24. After blocks 106 to 110 have been executed, the wireless device 24 is directed to execute block 112.

If by executing block 104 the wireless device 24 determines that the system 10 application is installed in the wireless device 24, then the wireless device 24 is directed to execute block 112.

Block 112 directs the wireless device 24 to launch the system 10 application.

After the system 10 application has been launched, the wireless device 24 is preferably operable to receive a user request for a list of tasks by executing block 114. The wireless device 24 is also preferably operable to obtain any necessary user account information, create a user account for the user, permit the user to determine a login password, and to perform other related functions, for example. The system 10 is operable to perform such user account features before or after executing block 114, although typically not before executing block 104. Such user account features may be performed as part of the installation process of block 110, for example. Although not shown in FIG. 6, it will be appreciated that a user may simply quit the system 10 application without providing such user request, in which case the method 96 terminates.

Block 116 directs the wireless device 24 to download from the server 12 the list of tasks in response to the user request (see block 114). Each listed task is preferably stored in the server 12 or its database 14 as a task data structure prior to downloading. The wireless device 24 is preferably operable to download each task data structure from the server 12 in a manner identical, similar or analogous to that of executing method 40 (FIG. 3). In some instances, the task data structure may include a response case record that can be opened by the wireless device 24, such as by executing block 56 (FIG. 4A). Additionally or alternatively, the wireless device 24 is preferably operable to create a response case record for association with a downloaded task, such as by executing block 58 (FIG. 4A) for example.

After executing block 11 6, the wireless device 24 is directed to exit the method 96. Upon exiting the method 96, the system 10 is preferably operable to execute the method 86 (FIG. 5), for example.

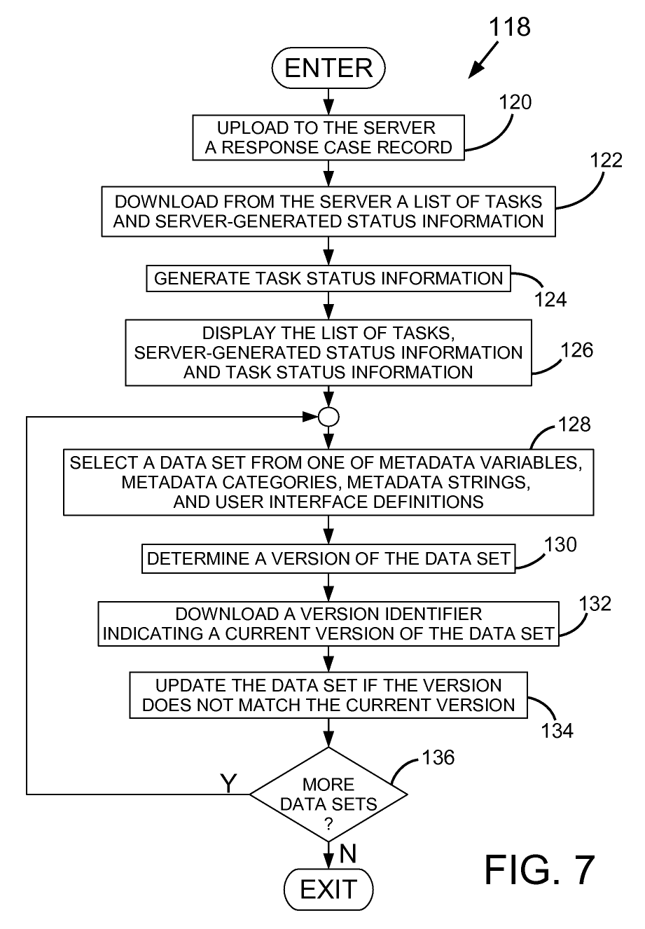

Referring to FIG. 7, the system 10 is operable to synchronize data stored in the wireless device 24 and data stored in the server 12 or database 14 and to update data stored in the wireless device 24 with reference to data stored in the server 12 or database 14 during any connection period of time that communications are established between the server 12 and the wireless device 24. In the first embodiment, the system 10 is operable to effect such synchronization feature, such updating feature or both such synchronization and updating features at any during the execution of the methods of the present invention, including when the system 10 application is first launched, when a list of tasks is downloaded from the server 12 to the wireless device 24, when a list of tasks is first displayed on the display 26, when the display of a list of tasks is being refreshed, during execution of an on-save script command (such as when executing block 82 shown in FIG. 4C for example), when closing a response case record (such as when or directly after executing block 84 shown in FIG. 4C for example), and in response to a user request for synchronization and/or updating, for example.

An exemplary method for synchronizing and updating data is shown in FIG. 7 generally at 118. The method 118 begins by executing block 120, which directs the wireless device 24 to upload a response case record to the server 12. The response case record selected for uploading may be any response case record stored in the wireless device 24, and such selection may depend on the context in which the method 118 was originally invoked. For example, the currently selected response case record for other processing purposes may be the response case record that is uploaded. As a further example, executing an on-save script command may invoke the selection of the response case record being saved. Additionally or alternatively, the system 10 is operable to permit a user to select a response case record for uploading.

Block 122 directs the wireless device 24 to download from the server 12 a list of tasks, and directs the wireless device 24 to download from the server 12 server-generated status information. While FIG. 7 shows the task downloading feature and the server-generated status information features as being executed by the same block 122, such features may also be separately executed, and one such feature may be executed without executing the other feature. In the first embodiment, the system 10 is operable to execute the task downloading feature in a manner identical, similar or analogous to executing block 116 (FIG. 6), including downloading task data structures for the listed tasks. The system 10 is preferably operable to download the server-generated status information as an optional feature. Status-generated status information may include status information about tasks not already downloaded to the wireless device 24, for example. By way of illustration, such server-generated status information may include an indication of the number of tasks that have been completed for a given third-party customer using a number of different wireless devices 24, for example.

Block 124 directs the wireless device 24 to generate task status information, which may be any status information about one or more tasks for which tasks data structures have been downloaded to the wireless device 24, thereby facilitating the generation by the wireless device 24 of such task status information.

Block 126 directs the wireless device 24 to display on the display 26 of the wireless device 24 the list of tasks (for which task data structures have been downloaded by executing block 122 for example), displaying on the display 26 the server-generated status information (downloaded by executing block 122 for example), and displaying on the display 26 the task status information (generated by executing block 124 for example). One or more display commands in accordance with a cross-platform specification may be executed, and/or platform-specific display commands may be invoked, for example.

While FIG. 7 shows blocks 120 to 126 as forming a part of method 118, blocks 120 to 126 may be implemented in some embodiments as a synchronization method separate from the remaining steps of the method 118, for example.

Still referring to FIG. 7, block 128 directs the wireless device 24 to select a data set from the group of: metadata variables, metadata categories, metadata strings, and user interface definitions. In the first embodiment, the system 10 is operable to make such selection from the metadata associated with a given case response record. Selecting the data set as a subset of the metadata stored within the given case response record advantageously permits the system 10 to update only those portions of the metadata which are not already updated.

Block 130 directs the wireless device 24 to determine a version of the data set selected by executing block 128. The system 10 is preferably operable to determine the version by any suitable technique, including retrieving a version number stored within the response case record.

Block 132 directs the wireless device 24 to download a version identifier indicating a current version of the data set. The system 10 is preferably operable to determine the current version by any suitable technique, including retrieving the version identifier stored within the instance of the response case record stored at the server 12 or database 14 for example.

Block 134 directs the wireless device 24 to update the data set if the version does not match the current version. For example, if the version number retrieved from the response case record has a different value from the version identifier obtained from the server 12, then the data set is updated. In the first embodiment, the system 10 is operable to update the data set by downloading a an updated data set from the server 12 to replace the data set of the response case record.

Block 136 directs the wireless device 24 to determine whether any more data sets are to be tested for updating. If more data set are to be tested for updating, then the wireless device 24 is directed to execute block 128 again. If no more data sets are to be tested for updating, then the wireless device 24 is directed to exit the method 118.

While FIG. 7 illustrates the exemplary blocks 128 to 136 for updating data sets of a given response case record, it will be appreciated that the system 10 is preferably operable to execute blocks 128 to 136 once for each response case record to be updated among a plurality of response case records.

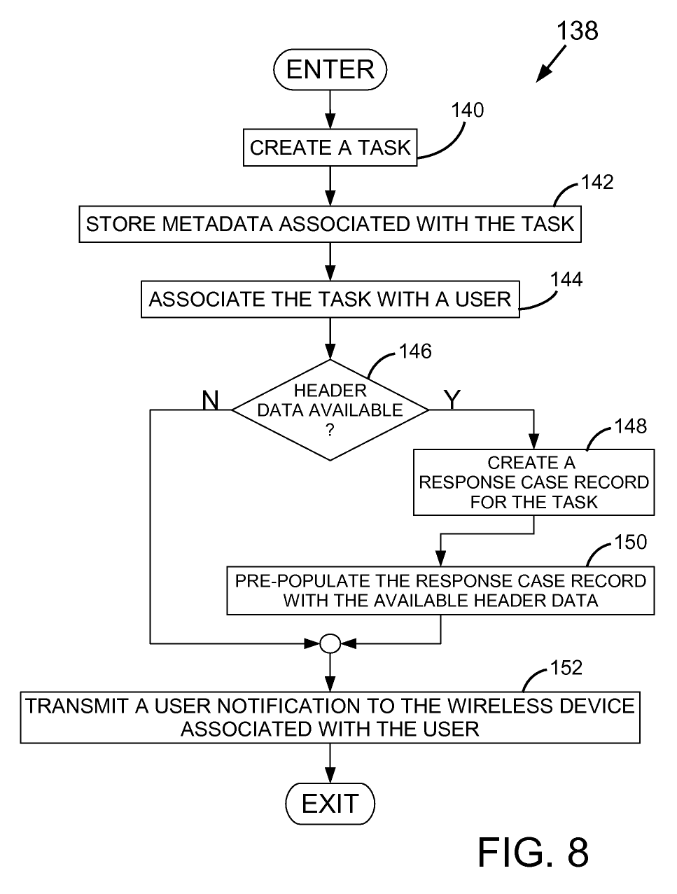

Referring to FIG. 8, the server 12 is preferably operable to prepare a task to be performed by a user using the wireless device 24. An exemplary method for preparing a task is shown in FIG. 8 generally at 138. The method 138 begins by executing block 140, which directs the server 12 to create a task. The server 12 is preferably operable to create a task by creating an instance of a task data structure.

Block 142 directs the server 12 to store metadata associated with the task created by executing block 140. In the first embodiment, the server 12 is preferably operable to store a metadata record comprising the metadata within the task data structure such that the metadata is associated with the task. In some embodiments, the metadata record is stored separately from the task data structure, and can be associated with the task data structure by linking techniques generally known in the art.

Block 144 directs the server 12 to associate the task with a user. Associating the task with the user may involve storing device identification identifying a given wireless device 24 within or in association with the task data structure, thereby associating the task with the owner or other user of the wireless device 24.

In some instances, however, it is desirable to make use of known contact information for the individual user. Block 146 directs the server 12 to determine whether such contact information is available as header data. If header data is available, the server 12 is directed to execute block 148.

Block 148 directs the server 12 to create a response case record for the task. Creating the response case record typically includes storing the response case record within or in association with the task data structure.

Block 150 then directs the server 12 to pre-populate the response case record (created by executing block 148 for example) with the available header data, typically by storing the available header data within the response case record for later retrieval by the wireless device 24 for example. After executing block 150, the server 12 is directed to execute block 152.

If no header data is available, then the server 12 is directed to execute block 152.

Block 152 directs the server 12 to transmit a user notification to the wireless device 24 associated with the user. Typically, such user notification notifies the user of the availability of the task assigned to the user by block 144, and may invite the user to participate in performing the assigned task. Such user notification may be received by the wireless device 24 by executing block 98 (FIG. 6), for example.

After block 152 is executed, the server 12 is directed to exit the method 138.

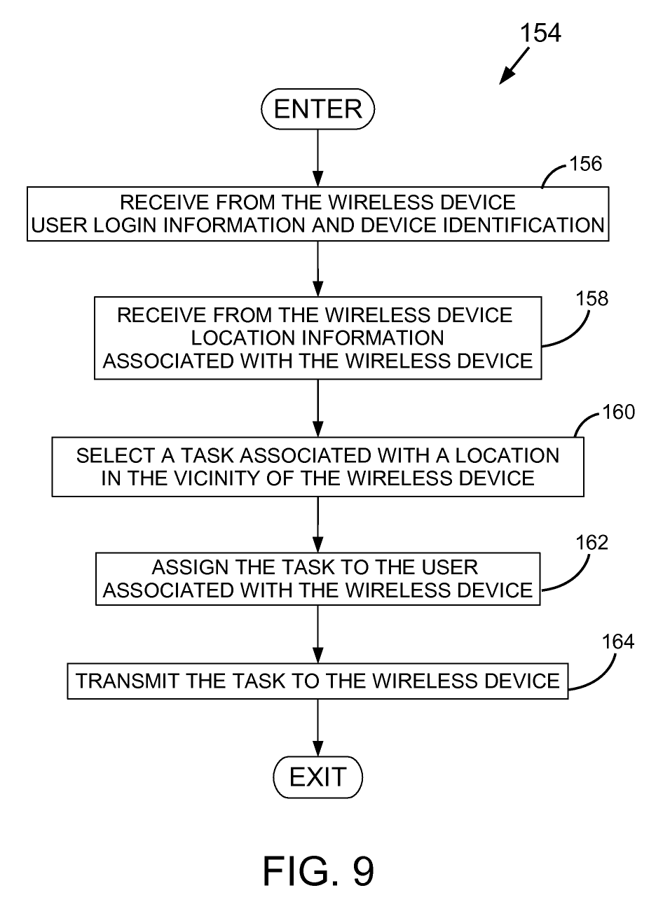

Referring to FIG. 9, the server 12 is in some embodiments operable to assign location-based tasks to users at known locations. An exemplary method for assigning a location-based task is shown in FIG. 9 generally at 154. The method 154 begins by executing block 156, which directs the server 12 to receive from the wireless device 24 user login information and device identification. The feature of receiving user login information is not implemented in some embodiments of the invention.

Block 158 directs the server 12 to receive from the wireless device 24 location information associated with the wireless device 24. Such location information may have been transmitted by the wireless device 24 for uploading to server 12 by executing block 44 (FIG. 3). The server 12 is preferably operable to receive such location information from any wireless devices 24 operable to upload such location information.

Block 160 directs the server 12 to select a task associated with a location in the vicinity of the wireless device 24 that uploaded the location information. Tasks associated with a location in the vicinity of the wireless device 24 includes tasks associated with the location indicated by the uploaded location information. For example, it may be desirable to have a user perform a task at or within a specifiable distance from a given location. A digital representation of the given location may be stored within or in association with the task data structure. If the location information received from the wireless device 24 indicates that the wireless device 24 is located at a point that is within a specifiable maximum distance of the given location, then the given location is within the vicinity of the wireless device 24 and the task is selected by the server 12.

Block 162 directs the server 12 to assign the task (selected by executing block 160 for example) to the user associated with the wireless device 24 that uploaded the location information. Block 162 may be implemented in a manner identical, similar or analogous to executing block 144 (FIG. 8), for example.

Block 164 directs the server 12 to transmit the task to the wireless device 24. The server 12 is preferably operable to transmit the task data structure comprising the metadata record, which contains the metadata and the metadata variable, and the response case record, if any, to the wireless device 24, thereby transmitting the task. Transmitting the task may involve transmitting a plurality of task data structures associated with different tasks. Additionally or alternatively, transmitting a list of available tasks and subsequently transmitting one or more of the listed tasks upon receiving from the wireless device 24 a selection of such one or more listed tasks, for example. Transmitting the task may correspond with the wireless device 24 downloading a metadata variable in accordance with block 30 (FIG. 2), downloading a metadata record in accordance with block 46 (FIG. 3), downloading a response case record in accordance with block 50 (FIG. 3), downloading a list of tasks in accordance with block 116 (FIG. 6), downloading a list of tasks in accordance with block 122 (FIG. 7), or similar or analogous operations of the wireless device 24 for example.

Transmitting the task in accordance with block 164 provides such task to the wireless device 24 for further processing by the wireless device 24, such by executing the method 52 (FIG. 4A) or the method 86 (FIG. 5), for example. After block 164 is executed, the server 12 is directed to exit from the method 154.

Additionally, the server 12 is preferably operable to execute a number of other user management, task management, data management and social research project management operations, including event time tracking, generating reminders and alarms, transmitting user reminder notifications, allocating permissions for data access, maintaining and managing the contents of the database 14, generating reports, exporting data, performing billing operations, performing other operations, and combinations thereof.

Thus, there is provided a method of conducting a survey by a wireless device having a memory circuit and a display screen, the wireless device being capable of wireless communication with a server during a connection period. The method includes the steps of: (a) downloading from the server during the connection period a metadata variable; (b) displaying on the display screen of the wireless device presentation information associated with the metadata variable; (c) receiving user input in response to the presentation information; (d) after receiving the user input, allocating memory of the memory circuit for storing the user input in association with the metadata variable; and (e) storing the user input in the memory in association with the metadata variable.

While embodiments of the invention have been described and illustrated, such embodiments should be considered illustrative of the invention only. The invention may include variants not described or illustrated herein in detail. For example, in some embodiments various script commands associated with a given metadata record may be stored together as a script separately from the user interface definitions stored in the given metadata record. Thus, the embodiments described and illustrated herein should not be considered to limit the invention as construed in accordance with the accompanying claims.

What is claimed is:

1. A method of conducting a survey by a wireless device having a memory circuit and a display screen, the wireless device being capable of wireless communication with a server during a connection period, the method comprising the steps of:
(a) downloading from the server during said connection period a metadata variable;
(b) displaying on said display screen of the wireless device presentation information associated with said metadata variable;
(c) receiving user input in response to said presentation information;
(d) after receiving said user input, allocating memory of said memory circuit for storing said user input in association with said metadata variable; and
(e) storing said user input in said memory in association with said metadata variable.

2. The method of claim 1 wherein said step (a) comprises downloading from the server a script command, and further comprising executing said script command at an event time selected from the group consisting of: a first event time prior to generating said presentation information, and a second event time after receiving said user input.

3. The method of claim 2 wherein said step (a) comprises downloading a metadata record, said metadata record containing metadata, said metadata comprising said metadata variable, a user interface definition, and at least one of a metadata category and a metadata string, and wherein said user interface definition comprises said script command.

4. The method of claim 1 wherein said step (a) comprises downloading a response case record, said response case record comprising stored user input.

5. The method of claim 1 wherein said step (a) comprises downloading a response case record, said response case record comprising header data.

6. The method of claim 1 wherein said step (a) comprises downloading a data set from the group consisting of: metadata of a variable definition type, metadata of a category type, metadata of a string type, and metadata of a user interface type, and further comprising:
(a) determining a version of said data set;
(b) downloading from the server a version identifier indicating a current version of said data set; and
(c) updating said data set if said version does not match said current version.

7. The method of claim 1 wherein said step (b) comprises executing a display command in accordance with a cross-platform software specification.

8. The method of claim 4 wherein said step (b) comprises generating said presentation information in accordance with said metadata.

9. The method of claim 1 further comprising storing a display identification in said memory circuit in association with said presentation information.

10. The method of claim 1 further comprising uploading to the server a location associated with the wireless device and downloading from the server a metadata record associated with said location, said metadata record comprising said metadata variable.

11. The method of claim 1 wherein said step (a) comprises downloading a response case record, and further comprising generating status information in accordance with said response case record, and displaying said status information on said display screen.

12. The method of claim 1 further comprising creating a response case record, associating said response case record with said metadata variable, generating status information in accordance with said response case record, and displaying said status information on said display screen.

13. A system for conducting a survey by a wireless device having a memory circuit and a display screen, said wireless device being capable of wireless communication with a server during a connection period, the system comprising:
(a) said server; and
(b) a plurality of said wireless devices, each said wireless device being operable to perform the method steps of claim 1.

14. The system of claim 13 wherein said server is operable to create said metadata variable, a metadata record and a task data structure, operable to store said metadata variable within said metadata record, operable to store said metadata record within said task data structure, and operable to associate said task data structure with one or more of said wireless devices.

15. The system of claim 14 wherein said server is operable to create a response case record and header data, and operable to store said header data within said response case record.

16. The system of claim 14 wherein said server is operable to create a plurality of said task data structures, operable to receive from one or more of said wireless devices location information, and operable to associate one or more of said task data structures with one or more of said wireless devices in response to said location information.

17. The system of claim 14 wherein said server is operable to transmit said task data structure to said wireless device, and wherein said wireless device is operable to download said task data structure from said server and to display on said display screen one or more tasks associated with said task data structure.

18. A wireless device for conducting a survey, the wireless device having a memory circuit and a display screen, the wireless device being capable of wireless communication with a server during a connection period, the wireless device comprising:
(a) downloading means for downloading from the server during said connection period a metadata variable;
(b) displaying means for displaying on said display screen of the wireless device presentation information associated with said metadata variable;
(c) receiving means for receiving user input in response to said presentation information;
(d) allocating means for, after receiving said user input, allocating memory of said memory circuit for storing said user input in association with said metadata variable; and
(e) storing means for storing said user input in said memory in association with said metadata variable.

19. The wireless device of claim 18, further comprising generating means for generating said presentation information.

20. A computer program product comprising computer-executable instructions embodied in a computer-readable medium for performing the method of claim 1.
